(19) United States
(12) Patent Application Publication
(10) Pub. No.: US 2025/0028576 A1
(43) Pub. Date: Jan. 23, 2025

(54) ADAPTIVE SCHEDULING FOR EXECUTING MACHINE LEARNING OPERATIONS IN A MULTIPROCESSOR COMPUTING DEVICE

(71) Applicant: QUALCOMM Incorporated, San Diego, CA (US)

(72) Inventors: Nan ZHANG, Beijing (CN); Yongjun XU, Beijing (CN); Zhiguo LI, Beijing (CN)

(21) Appl. No.: 18/714,036

(22) PCT Filed: Feb. 28, 2022
(86) PCT No.: PCT/CN2022/078212

§ 371 Date: May 28, 2024

(51) Int. Cl. G06F 9/50

(52) U.S. Cl. CPC G06F 9/5094; G06F 9/5038; G06F 9/505

(57) ABSTRACT

Certain aspects of the present disclosure provide techniques and apparatus for scheduling execution of machine learning model operations on a multiprocessor computing device. The method generally includes during execution of operations in a first portion of a machine learning model on a first processing unit of the computing device, measuring a temperature for each of a plurality of locations on the computing device. It is determined that a temperature measured for the first processing unit exceeds a threshold temperature. Based on one or more operating parameters for the computing device, a second processing unit of the computing device is selected to use in executing operations in a second portion of the machine learning model. Execution of operations in the second portion of the machine learning model on the second processing unit is scheduled.

### INTRODUCTION

Aspects of the present disclosure relate to machine learning and, more particularly, to scheduling execution of portions of a machine learning model on a computing device having multiple processors.

In various computing systems, such as on smartphones, tablet computers, or the like, multiple processors may be used to perform various computing tasks, such as processing different portions of a neural network (e.g., different layers, groups of layers, network branches, subnetworks, etc.) or other machine learning model. These processors may have different performance, power utilization, and thermal characteristics. For example, in a computing device including one or more central processing unit (CPU) cores, one or more graphics processing units (GPUS), a neural processing unit (NPU), one or more digital signal processors (DSPs), and the like, each of these processors may be suited (e.g., specifically optimized) for specific types of tasks and may generate different amounts of heat when under load. A CPU core, for example, may provide less performance for a specific task relative to more specialized processing units, such as GPUs, NPUs, or DSPs, and may use more power and thus generate more heat when under load. Conversely, a more specialized processing unit may provide more performance while consuming less power and generating less heat than specialized processing units performing the same task.

Processing units in a computing device generally operate within a thermal window defined by floor and ceiling operating temperatures for these processing units and for other components in the computing device (e.g., case temperature for a mobile device, so that the computing device can be held by a user without burning the user, battery temperature so as to minimize a likelihood of thermal runaway or other negative effects of heat on battery life, etc.). As a processing unit approaches various threshold temperatures up to a thermal ceiling, various actions may be taken to reduce the amount of heat generated by these processing units. For example, the core voltage for the processor may be reduced, reducing the clock speed at which the processing unit operates. While reducing the clock speed at which the processing unit operates may result in the generation of less heat, doing so may also reduce system performance.

Accordingly, what is needed are improved techniques for heat management in computing systems executing machine learning operations.

### BRIEF SUMMARY

Certain aspects provide a computer-implemented method for scheduling execution of machine learning model operations on a multiprocessor computing device. The method generally includes during execution of operations in a first portion of a machine learning model on a first processing unit of the computing device, measuring a temperature for each of a plurality of locations on the computing device. It is determined that a temperature measured for the first processing unit exceeds a threshold temperature. Based on one or more operating parameters for the computing device, a second processing unit of the computing device is selected to use in executing operations in a second portion of the machine learning model. Execution of operations in the second portion of the machine learning model on the second processing unit is scheduled.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods, as well as those further described herein.

The following description and the related drawings set forth in detail certain illustrative features of one or more embodiments.

### BRIEF DESCRIPTION OF THE DRAWINGS

The appended figures depict certain aspects of the one or more embodiments and are therefore not to be considered limiting of the scope of this disclosure.

FIG. 1 depicts an example layout of a multiprocessor computing device.

FIG. 2 illustrates an example architecture of a neural network in which layers in the neural network are organized into groups configured for processing on different sets of processing units in a computing device, according to aspects of the present disclosure.

FIG. 3 illustrates example operations for adaptively scheduling execution of operations in a machine learning model on a multiprocessor computing device, according to aspects of the present disclosure.

FIG. 4 illustrates an example implementation of a processing system in which adaptive scheduling of execution of operations in a neural network can be performed, according to aspects of the present disclosure.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Aspects of the present disclosure provide techniques for adaptively scheduling execution of operations in a neural network on a multiprocessor computing device.

Machine learning models, such as convolutional neural networks, recurrent neural networks, and the like can be used for various tasks. For example, neural networks may be used for spatial scaling to use artificial intelligence techniques in adjusting the resolution of an image (e.g., using super resolution techniques to increase the resolution of an input image), for temporal interpolation to allow for frames to be generated at higher frame rates (e.g., corresponding to the refresh rate of a display on which the frames are to be displayed), in adjusting the appearance of an image (e.g., through image fusion, applying various color effects, such as generating high dynamic range (HDR) imagery, introducing background or foreground blur (also known as “bokeh”), etc.). In various scenarios, such as in video playback, game play, or the like, these operations may be performed in real time or near real time, and thus, a significant amount of processing power may be dedicated to performing these tasks.

Because performing these various compute tasks using neural networks in real time or near real time may be a computationally expensive task, the processors on which these tasks are executed may draw a significant amount of power in order to dedicate a sufficient amount of computational resources to these tasks. However, due to the resistive properties of various components and circuits within the computing device, the increase in current draw may result in a corresponding increase in operating temperature for various components of the computing device. In some cases, continued execution of operations using a neural network may cause components in the computing device to reach one or more thermal limits defined for the safe and reliable operation of the computing device (e.g., maximum temperatures defined for a processor before the processor is damaged, maximum temperatures defined for a battery to avoid thermal runaway or other destructive events, maximum temperatures defined for the case of a computing device to prevent a user from being burned, etc.). When these thermal limits are reached, various actions may be taken to keep the computing device within its defined thermal limits. For example, the clock speed at which these processors operate, and the corresponding current draw for these processors, may be reduced. However, the reduction in clock speed may increase the amount of time needed for operations to execute. For tasks that are to be performed in real time or near real time, such as video processing, in-game image rendering, and the like, this may introduce “choppiness” into the operation. For example, in a video processing application, frames may be dropped, which may cause the resulting video to not appear to be smooth.

### Example Computing Device Architecture

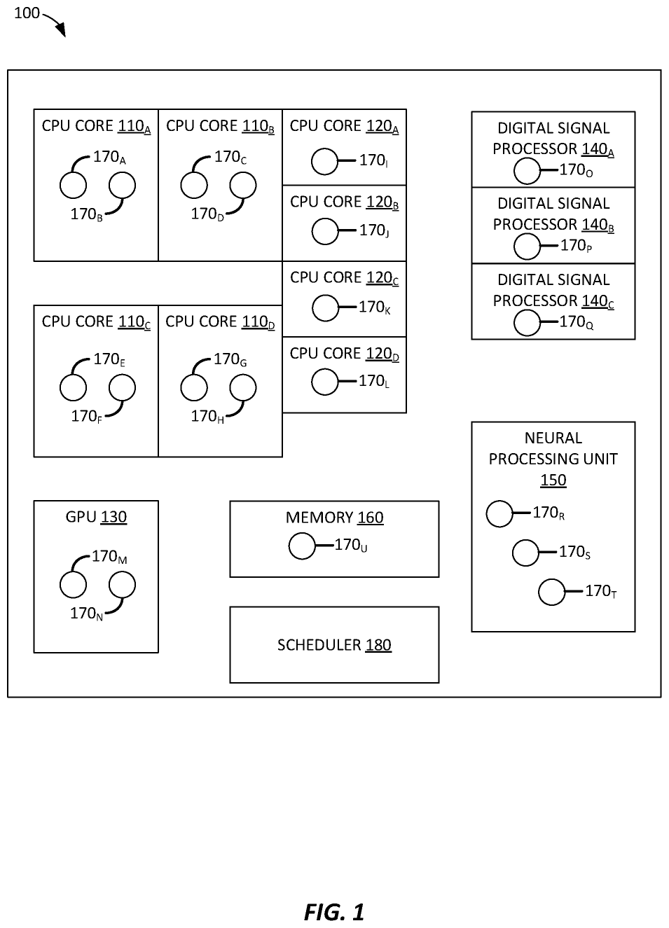

FIG. 1 illustrates an example computing device 100 including a plurality of processors on which operations in a neural network can be performed. As illustrated, computing device 100 includes a plurality of central processing unit (CPU) cores 110, a plurality of central processing unit (CPU) cores 120, a graphics processing unit (GPU) 130, a plurality of digital signal processors (DSPs) 140, a neural processing unit (NPU) 150, a memory 160 accessible by CPU cores 110, CPU cores 120, GPU 130, DSPs 140, and NPU 150, and a plurality of temperature sensors 170.

The plurality of CPU cores 110 and the plurality of CPU cores 120 may, in some aspects, be part of a heterogeneous CPU architecture (such as a big. LITTLE architecture in an Advanced RISC Machine (ARM) processor) in which CPU cores 110 are designated as “performance” cores and CPU cores 120 are designated as “efficiency” cores. CPU cores 110 may provide additional processing capabilities relative to CPU cores 120, but may draw more power in order to provide these additional processing capabilities. In contrast, CPU cores 120 may be power-efficient cores that allow for the completion of computing tasks that are less computationally complex using less power than CPU cores 110. Various operating parameters may thus be used to schedule execution of tasks across CPU cores 110 and CPU cores 120 to leverage the processing capabilities of CPU cores 110 and the power efficiency of CPU cores 120. For example, complex computational tasks, such as tasks involving large numbers or floating point data types, may be scheduled for execution on CPU cores 110, while tasks involving small numbers or integer data types may be scheduled for execution on CPU cores 120, as the tasks involving small numbers or integer data types may not need to leverage the additional processing characteristics of CPU cores 110.

GPU 130 generally may be a processing unit including a plurality of units that may allow for parallel execution of various operations. In some aspects, GPU 130 may be configured to execute vector math operations and other complex mathematical operations that may be used to generate graphics for display on a display device connected with or integral to computing device 110. Because GPU 130 may support parallel processing for complex tasks such as vector math operations, GPU 130 may also be used in performing various tasks in a neural network with a level of performance greater than that of CPU cores 110 or CPU cores 120.

DSPs 140 may perform signal processing on various data inputs in order to generate a processed signal output. In some aspects, these DSPs may be associated with various image capture, sound capture, or other data capture devices connected with or integral to computing device 100. For example, DSP 140A may be associated with a first camera of a mobile device (e.g., a wide angle camera), DSP 140B may be associated with a second camera of the mobile device (e.g., a camera with a “normal” field of view, or a field of view approximating that of a human), DSP 140c may be associated with a video camera of the mobile device, and so on.

NPU 150 generally may be a specialized processing unit that executes operations involving various machine learning algorithms. Generally, NPU 150 may perform various prediction tasks, convolution tasks, subsampling tasks, and the like within a neural network. For example, NPU 150 may be designed to process data structured as highly dimensional tensors in parallel and may include a buffer of a sufficient size to allow for data reuse within a neural network. Because NPU 150 is a specialized processing unit that is tailored to execution of tasks within a neural network, general tasks that can be executed on CPU cores 110 and/or CPU cores 120 may not be scheduled on NPU 150.

During execution of various operations on computing device 100, a scheduler 180 may periodically or aperiodically measure the operating temperatures for each of CPU cores 110, CPU cores 120, GPU 130, DSPs 140, and NPU 150 via temperature sensors 170. As illustrated, varying numbers of temperature sensors may be implemented on each processing unit in computing device 100. For example, each of CPU cores 110 (e.g., the “performance” cores) may include two temperature sensors 170, while each of CPU cores 120 (e.g., the “efficiency” cores) may include a single temperature sensor 170. Additional temperature sensors 170, though not illustrated, may also be implemented in computing device 100 to measure the operating temperature of other components of the computing device.

As discussed, each of the processing units (and other components) in computing device 100 may have defined operating temperature ceilings. Generally, a processing unit may not be allowed to operate above the defined operating temperature ceiling for the processing unit, as exceeding the defined operating temperature ceiling may cause damage to the processing unit or to other components in the computing device 100. Typically, to prevent a processing unit from exceeding the defined operating temperature ceiling, various power control techniques can be used to reduce the clock speed (or rate at which instructions are executed) of the processing unit, and thus, to reduce the amount of heat generated by the processing unit. However, reducing the clock speed of the processing unit may negatively impact the operations that are being executed on the processing unit.

To allow for machine learning operations (e.g., via a neural network) to be adaptively executed on computing device 100, temperature measurements, known distances between different processing units on computing device 100, and other operational parameters can be used to schedule execution of machine learning operations. Generally, because the layout of the processing units in the computing device 100 is known and fixed for a specific design of a specific computing device 100, and because heat can be assumed to dissipate as a function of distance, a scheduler 180 can assume that processing units that are further away from the processing unit that is currently executing neural network operations may be more suitable for use in future execution of neural network operations than processing units that are closer to the processing unit that is currently executing machine learning operations. Effectively, thus, a scheduler 180 may move execution to processing units that are cooler than the current processing unit that is currently executing the machine learning operations while maintaining the processing capabilities needed in order to execute the machine learning operations with a desired level of performance (e.g., the generation of frames in a video or in streaming content according to a defined refresh rate such that transitions between frames appears smooth).

For example, suppose that machine learning operations can be configured for execution on NPU 150, GPU 130, and CPU cores 110 in that order of prioritization. Thus, assuming that each of NPU 150, GPU 130, and CPU cores 110 are idle and below a thermal threshold (e.g., a thermal ceiling), machine learning operations may be initially scheduled for execution by NPU 150. If one or more of temperature sensors 170R-170T indicate that the temperature of NPU 150 is approaching or at a thermal threshold, scheduler 180 can determine that subsequent execution of machine learning operations should be moved to GPU 130 or one or more CPU cores 110. Assuming that, at this time, GPU 130 and the CPU cores 110 have measured temperatures that are below the thermal ceiling defined for these processing units, scheduler 180 can consider distance from the NPU 150 and other operating parameters in identifying which of GPU 130 or CPU cores 110 to use in subsequent execution of machine learning operations. In this example, because GPU 130 is closer to NPU 150 than CPU cores 110, a scheduler 180 may consider GPU 130 a less suitable candidate than CPU cores 110 for use in subsequent execution of machine learning operations. Thus, scheduler 180 may schedule subsequent execution of machine learning operations for one or more of CPU cores 110. In some aspects, distance metrics may be calculated on a per-processing-unit basis. In such a case, because CPU core 110A is the processing unit that is the furthest distance from NPU 150, CPU core 110A may be selected as the processing unit to use in subsequent execution of machine learning operations on computing device 100.

Other operational parameters may alternatively or additionally used to determine which processing units to use in subsequent execution of machine learning operations on a computing device 100. For example, a current load on each processing unit may be considered in determining whether a specific processing unit is a candidate for use in subsequent execution of machine learning operations. If a processing unit has a current load exceeding a threshold value, the processing unit may not be considered a suitable candidate for subsequent execution of machine learning operations. This threshold value may be defined a priori or configured for each processing unit based, for example, on the performance characteristics of each processing unit. More powerful processing units (e.g., processing units that can process a larger number of operations over a given time period) may have higher usage thresholds, for example, than less powerful processing units, as more powerful processing units may have additional resources that can be dedicated for use in performing other operations than less powerful processing units. In another example, the current temperature of each processing unit can be used in determining whether a processing unit is a candidate for subsequent execution of machine learning operations. Generally, because machine learning operations may be computationally intensive and thus be likely to increase the temperature of any processing unit on which these operations are executed, processing units that have temperatures closer to their thermal ceilings or other defined thermal thresholds may be less suitable for use in subsequent execution of machine learning operations than processing units that have temperatures further away from their thermal ceilings or other thermal thresholds. It should be understood, however, that current loading, temperature, and distance from the processing unit that is currently executing machine learning operations are but examples of operational parameters that may be considered in selecting the processing units on which subsequent machine learning operations are to be executed, and other operational parameters may be used in conjunction with or in lieu of the operational parameters discussed herein.

### Example Neural Network Architecture

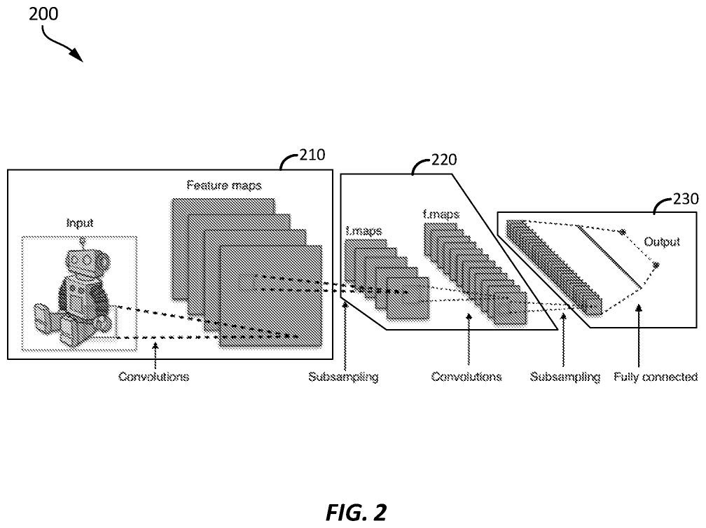

FIG. 2 illustrates an example architecture of a neural network 200 in which layers in the neural network are organized into groups configured for processing on different sets of processing units in a computing device (e.g., one or more of CPU cores 110, CPU cores 120, GPU 130, DSPs 140, and NPU 150 of computing device 100 illustrated in FIG. 1), according to aspects of the present disclosure.

Generally, a neural network 200 may include a plurality of layers, and each layer may have a different level of complexity. For example, layers closer to the input used to generate feature maps from the input may be the most complex layers in the neural network, and layers that perform operations on subsampled data sets output from previous layers may be less complex. Because the complexity involved in performing operations in a neural network may be known, or at least estimated (e.g., based on parameter counts, node counts, input size, etc. in the neural network), to decrease as the neural network gets closer to generating an output representing the input, the layers in the neural network may be grouped into a plurality of groups. Each group may be configured for execution on specific processing units within computing device 100, and a preference for executing operations in a group of layers in the neural network may also be defined.

For example, as illustrated, neural network 200 may be grouped into first group 210, second group 220, and third group 230. The first group 210 of layers in the neural network 200 may be configured for execution on DSPs 140, NPU 150, and CPU cores 110 and/or 120 in order of preference. The second group 220 of layers in the neural network 200, which may be considered less computationally complex than the layers in first group 210, may be configured for execution on DSPs 140, NPU 150, and GPU 130 in order of preference. Finally, the third group 230 of layers, which may be considered less computationally complex than the layers in second group 220, may be configured for execution on CPU cores 110 and/or 120 and GPU 130 in order of preference.

In some aspects, different layers in the neural network 200 may be configured for execution using different levels of quantization, or different granularities with which data can be generated. To allow for the different groups of layers to be configured, each layer included in a group of layers may be trained or compiled for execution using a same quantization level. For example, the first group 210 of layers (which, as discussed, may correspond to the group of layers with the highest computational complexity) may be trained or compiled for quantization within the 32-bit floating point number space (e.g., a space ranging between −3.4*10³⁸ and 3.4*10³⁸). The second group 220 of layers (which may correspond to a group of layers with less computational complexity than the first group 210 of layers) may be trained or compiled for execution using a less computationally complex data type, such as quantization within the 8-bit integer number space (e.g., a space ranging between −128 and 127 if signed, or between 0 and 255 if unsigned). The third group 230 of layers may thus be trained or compiled for executing using an even less computationally complex data type, such as quantization within a smaller integer number space (e.g., 6 bits, 4 bits, etc.). Generally, these different levels of quantization may be a constraint that limits the selection of processors to which subsequent machine learning operations can be transferred and/or make some processors better targets for scheduling subsequent machine learning operations. For example, if layers in a neural network are compiled for floating point quantization, processors that have better floating point processing capabilities (e.g., “performance” CPU cores, GPUs, NPUs, etc.) may be suitable for performing operations in these layers, while processors that lack floating point processing capabilities or have limited floating point processing capabilities (e.g., “efficiency” CPU cores, etc.) may not be suitable for performing operations in these layers.

While FIG. 2 illustrates the partitioning of a neural network into a plurality of groups of layers, it should be recognized that any machine learning model may be organized into similar groupings, and the partitioning of a neural network into the plurality of groups of layers is but one example of the partitioning of a machine learning model into different groups of components that can be scheduled for execution on different groups of processing units.

### Example Methods for Adaptive Scheduling of Machine Learning Operations in a Multiprocessor Computing Device

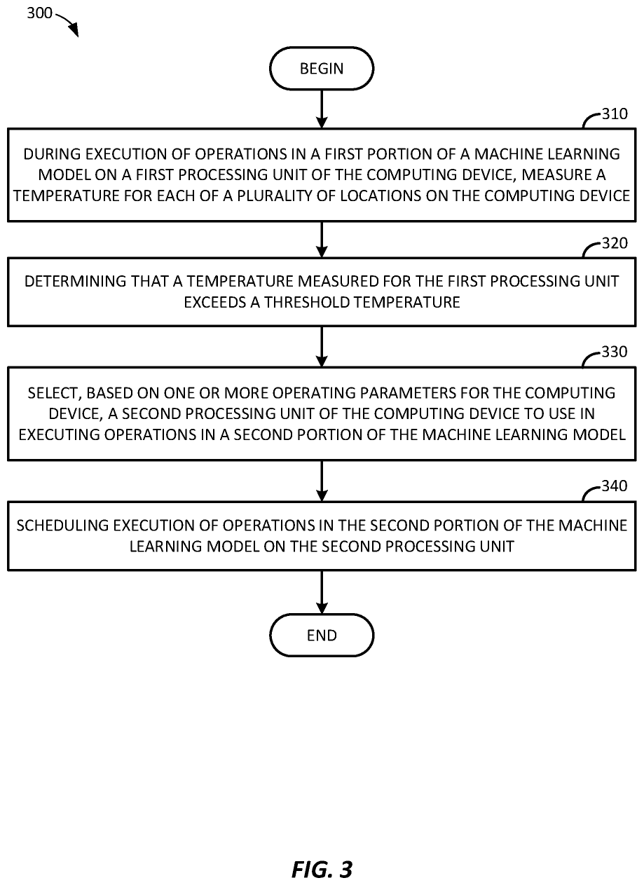

FIG. 3 illustrates example operations 300 that may be performed for adaptively scheduling execution of operations in a machine learning model on a multiprocessor computing device, such as computing device 100 illustrated in FIG. 1, according to aspects of the present disclosure.

As illustrated, operations 300 may begin at block 310, where, during execution of operations in a first portion of a machine learning model of a first processor of the multiprocessor computing device, the temperature for each processing unit of a plurality of processing units is measured. The measurements may be obtained by querying or otherwise polling one or more temperature sensors (e.g., temperature sensors 170 illustrated in FIG. 1), where each sensor is associated with a specific processing unit or other discrete component in the computing device. In some aspects, where a processing unit has multiple temperature sensors associated therewith, various techniques can be used to determine the temperature of the processing unit. For example, an average temperature across the multiple temperature sensors may be used as the temperature of the processing unit. In another example, the highest temperature measured across the multiple temperature sensors may be used as the temperature of the processing unit. In some aspects, the measured temperature may correspond to an instantaneous temperature reading; in other aspects, the measured temperature may be a running average over a most recent number of samples.

At block 320, operations 300 proceed with determining that a temperature measured for the first processing unit exceeds a threshold temperature.

At block 330, operations 300 proceed with selecting a second processing unit of the computing device for use in executing operations in a second portion of the machine learning model. Generally, the second processing unit may be selected based on one or more operating parameters for the computing device. These operating parameters may include, for example, a distance between the first processing unit and the second processing unit, a current load on the second processing unit, a current temperature of the second processing unit, or the like. Information such as the distance between the first processing unit and the second processing unit may be defined, for example, in a configuration file. For example, the configuration file may correspond to the physical layout of a computing device on which machine learning operations are performed and include information identifying the location of each processing unit in the computing device. In some aspects, the configuration file may include information identifying specific slots in which these processors are installed, and various assumptions may be made based on this information. For example, in a computing system in which processors are installed in expansion slots numbered from 0 through n, with expansion slot 0 being the closest to the CPU, relative distances between each processor in the computing system can be determined and used in selecting a processor to use in executing operations in a second portion of the machine learning model.

In some aspects, where distance from the first processing unit is one of the operating parameters used to select the second processing unit, the second processing unit may be selected as the processing unit having a temperature below a threshold temperature (e.g., a thermal ceiling defined for the processing unit, one of a plurality of thermal thresholds defining different levels of performance for a processing unit, etc.) that is the furthest away from the first processing unit.

In some aspects, the second processing unit may further be selected based on a ranking of types of processing units to use in executing operations in the second portion of the neural network. These rankings may be based, for example, on a size of data processed in the second portion of the machine learning model (e.g., a data type used for processing data in the second portion of the machine learning model, such as 32-bit floating point, 8-bit integer, etc.) and a level of performance (e.g., a number of floating point operations per second, integer operations per second, etc. supported by the processing units of the computing device) associated with each type of processing unit in the computing device.

In some aspects, the second processing unit may be selected by identifying a set of processing units having distances from the first processing unit exceeding a distance threshold and measured temperatures below a threshold temperature. The distance threshold may be an absolute distance between processing units (e.g., according to a known architectural layout of the computing device) or an assumed distance based on general rules defining the locations of processing units and expansion slots in the computing device. The second processing unit may be selected from the identified set of processing units. For example, the second processing unit may be selected from the identified set of processing units according to a ranking of these processing units (as discussed above), a current load on these processing units, and so on. In some aspects, the identified set of processing units may further be identified by identifying processing units having a current load less than a threshold load.

At block 340, execution of operations in the second portion of the machine learning model are scheduled for execution on the second processing unit.

In some aspects, the first portion of the machine learning model and the second portion of the machine learning model may be different layers of a neural network configured for execution on a same set of processing units. For example, the first portion of the machine learning model and the second portion of the machine learning model network may be layers of the neural network that are both configured to execute using a same data type on a same type of processor.

In some aspects, the first portion of the machine learning model may be a layer in a first set of layers of a neural network, and the second portion of the machine learning model may be a layer in a second set of layers in the neural network. The first set of layers may be configured for execution on a first set of processing units of the computing device. The second set of layers may be configured for execution on a second set of processing units of the computing device. For example, as discussed above with respect to FIG. 2, the first set of layers of the neural network and the second set of layers of the neural network may comprise sets of layers with differing levels of computational complexity. Generally, computational complexity information, such as data types used by different portions of a machine learning model (and corresponding assumptions about the computational complexity of operations in these different portions of the machine learning model), may be known in advance (e.g., through configuration information accompanying the machine learning model) and may be used to schedule subsequent machine learning operations on the computing device. The first set of layers may be configured with a first set of quantization parameters and the second set of layers may be configured with a second set of quantization parameters. The second set of quantization parameters, for example, may correspond to quantization over a smaller data type than the first set of quantization parameters. For example, the first set of layers may comprise layers in the neural network configured to process data using 32-bit floating point numbers, while the second set of layers may comprise layers in the neural network configured to process data using 8-bit integer numbers. Of course, it should be recognized that this is merely an example, and the first and second sets of layers may be configured to process and quantize data using varying data types.

In some aspects, the first set of processing units may include a neural processing unit (NPU), a digital signal processor (DSP), and a plurality of central processing unit (CPU) cores. Meanwhile, the second set of processing units may include the plurality of CPU cores and a plurality of graphics processing unit (GPU) processors. In such a case, if the first portion of the neural network is being executed on one or more CPU cores, the second portion of the neural network may thus be scheduled for execution using the GPU processors, as it may be assumed that the CPU cores are located relatively closer to the CPU cores on which the first portion of the neural network is executed and thus that the CPUs may not be suitable candidate processing units for use in executing operations using the second set.

### Example Processing System for Adaptive Scheduling of Machine Learning Operations in a Multiprocessor Computing Device

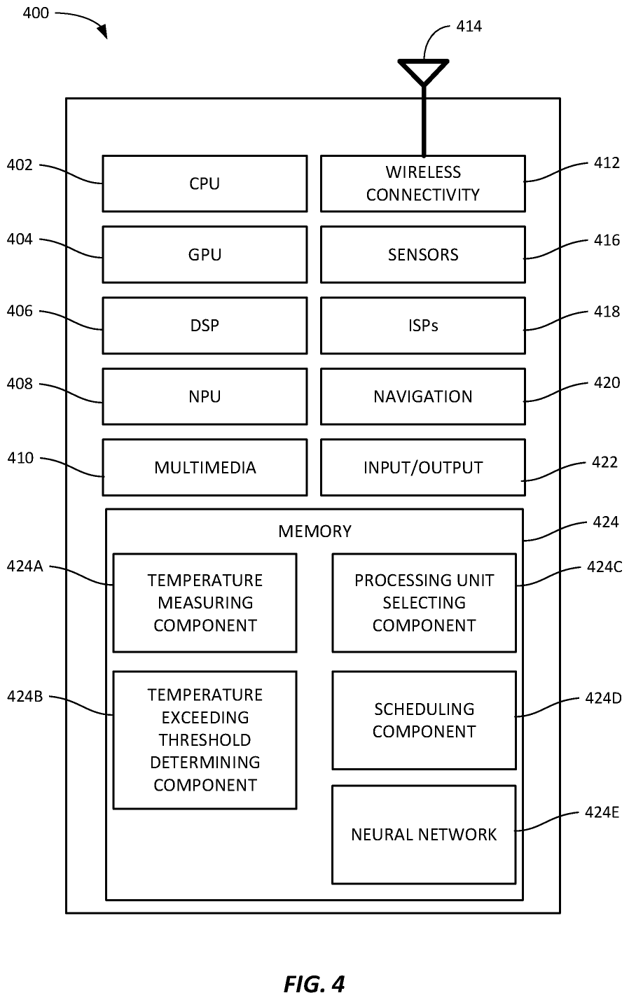

FIG. 4 depicts an example processing system 400 for adaptively scheduling execution of operations in a neural network on a multiprocessor computing device, such as described herein for example with respect to FIG. 3.

Processing system 400 includes a central processing unit (CPU) 402, which in some examples may be a multi-core CPU. Instructions executed at the CPU 402 may be loaded, for example, from a program memory associated with the CPU 402 or may be loaded from a partition in memory 424.

Processing system 400 also includes additional processing components tailored to specific functions, such as a graphics processing unit (GPU) 404, a digital signal processor (DSP) 406, a neural processing unit (NPU) 408, a multimedia processing unit 410, a multimedia processing unit 410, and a wireless connectivity component 412.

An NPU, such as 408, is generally a specialized circuit configured for implementing all the necessary control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing units (TPU), neural network processor (NNP), intelligence processing unit (IPU), vision processing unit (VPU), or graph processing unit.

NPUs, such as 408, are configured to accelerate the performance of common machine learning tasks, such as image classification, machine translation, object detection, and various other predictive models. In some examples, a plurality of NPUs may be instantiated on a single chip, such as a system on a chip (SoC), while in other examples they may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process it through an already trained model to generate a model output (e.g., an inference).

In one implementation, NPU 408 is a part of one or more of CPU 402, GPU 404, and/or DSP 406.

In some examples, wireless connectivity component 412 may include subcomponents, for example, for third generation (3G) connectivity, fourth generation (4G) connectivity (e.g., 4G LTE), fifth generation connectivity (e.g., 5G or NR), Wi-Fi connectivity, Bluetooth connectivity, and other wireless data transmission standards. Wireless connectivity component 412 is further connected to one or more antennas 414.

Processing system 400 may also include one or more sensor processing units 416 associated with any manner of sensor, such as temperature sensors 170 illustrated in FIG. 1, one or more image signal processors (ISPs) 418 associated with any manner of image sensor, and/or a navigation processor 420, which may include satellite-based positioning system components (e.g., GPS or GLONASS) as well as inertial positioning system components.

Processing system 400 may also include one or more input and/or output devices 422, such as screens, touch-sensitive surfaces (including touch-sensitive displays), physical buttons, speakers, microphones, and the like.

In some examples, one or more of the processors of processing system 400 may be based on an ARM or RISC-V instruction set.

Processing system 400 also includes memory 424, which is representative of one or more static and/or dynamic memories, such as a dynamic random access memory, a flash-based static memory, and the like. In this example, memory 424 includes computer-executable components, which may be executed by one or more of the aforementioned processors of processing system 400.

In particular, in this example, memory 424 includes temperature measuring component 424A, temperature exceeding threshold determining component 424B, processing unit selecting component 424C, scheduling component 424D, and neural network 424E. The depicted components, and others not depicted, may be configured to perform various aspects of the methods described herein.

Generally, processing system 400 and/or components thereof may be configured to perform the methods described herein.

Notably, in other embodiments, aspects of processing system 400 may be omitted, such as where processing system 400 is a server computer or the like. For example, multimedia processing unit 410, wireless connectivity component 412, sensor processing units 416, ISPs 418, and/or navigation processor 420 may be omitted in other embodiments. Further, aspects of processing system 400 may be distributed, such as training a model and using the model to generate inferences, such as user verification predictions.

### Example Clauses

Implementation examples are described in the following numbered clauses:

Clause 1: A method implemented on a computing device having multiple processing units, comprising: during execution of operations in a first portion of a neural network on a first processing unit of the computing device, measuring a temperature for each of a plurality of locations on the computing device; determining that a temperature measured for the first processing unit exceeds a threshold temperature; selecting, based on one or more operating parameters for the computing device, a second processing unit of the computing device to use in executing operations in a second portion of the neural network; and scheduling execution of operations in the second portion of the neural network on the second processing unit.

Clause 2: The method of Clause 1, wherein the first portion of the neural network and the second portion of the neural network comprise layers of the neural network configured for execution on a same set of processing units.

Clause 3: The method of any one of Clauses 1 or 2, wherein the first portion of the neural network is a member of a first set of layers configured for execution on a first set of processing units of the computing device and the second portion of the neural network is a member of a second set of layers configured for execution on a second set of processing units of the computing device.

Clause 4: The method of Clause 3, wherein the first set of layers comprise a set of layers configured with a first set of quantization parameters.

Clause 5: The method of Clause 4, wherein: the second set of layers comprise a set of layers configured with a second set of quantization parameters, and the second set of quantization parameters correspond to quantization over a smaller data type than the first set of quantization parameters.

Clause 6: The method of any one of Clauses 3 through 5, wherein the first set of processing units comprises a neural processing unit (NPU), a digital signal processor (DSP), and a plurality of central processing unit (CPU) cores.

Clause 7: The method of Clause 6, wherein the second set of processing units comprises the plurality of CPU cores and a plurality of graphics processing unit (GPU) processors.

Clause 8: The method of any one of Clauses 1 through 7, wherein selecting the second processing unit is further based on a ranking of types of processing units for executing operations in the second portion of the neural network.

Clause 9: The method of Clause 8, wherein the ranking of types of processing units is based on a size of data processed using the second portion of the neural network and a level of performance associated with each type of processing unit in the computing device.

Clause 10: The method of any one of Clauses 1 through 9, wherein the one or more operating parameters comprise one or more of a distance between the one or more processing units and the first processing unit, a temperature of the one or more processing units, or a current load on the one or more processing units.

Clause 11: The method of Clause 10, wherein selecting the second processing unit comprises selecting a processing unit a farthest distance away from the first processing unit having a measured temperature below a threshold temperature.

Clause 12: The method of any one of Clauses 10 or 11, wherein selecting the second processing unit comprises: identifying a set of processing units having distances from the first processing unit exceeding a distance threshold and measured temperatures below a threshold temperature; and selecting the second processing unit from the identified set of processing units.

Clause 13: The method of Clause 12, wherein identifying the set of processing units further comprises identifying processing units having a current load less than a threshold load.

Clause 14: A processing system, comprising: a memory comprising computer-executable instructions and one or more processors configured to execute the computer-executable instructions and cause the processing system to perform a method in accordance with any one of Clauses 1-13.

Clause 15: A processing system, comprising means for performing a method in accordance with any one of Clauses 1-13.

Clause 16: A non-transitory computer-readable medium comprising computer-executable instructions that, when executed by one or more processors of a processing system, cause the processing system to perform a method in accordance with any one of Clauses 1-13.

Clause 17: A computer program product embodied on a computer-readable storage medium comprising code for performing a method in accordance with any one of Clauses 1-13.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method implemented on a computing device having multiple processing units, comprising:
during execution of operations in a first portion of a machine learning model on a first processing unit of the computing device, measuring a temperature for each of a plurality of locations on the computing device;
determining that a temperature measured for the first processing unit exceeds a threshold temperature;
selecting, based on one or more operating parameters for the computing device, a second processing unit of the computing device to use in executing operations in a second portion of the machine learning model; and
scheduling execution of operations in the second portion of the machine learning model on the second processing unit.

2. The method of claim 1, wherein the first portion of the machine learning model and the second portion of the machine learning model comprise layers of a neural network configured for execution on a same set of processing units.

3. The method of claim 1, wherein the first portion of the machine learning model is a member of a first set of layers configured for execution on a first set of processing units of the computing device and the second portion of the machine learning model is a member of a second set of layers configured for execution on a second set of processing units of the computing device.

4. The method of claim 3, wherein the first set of layers comprise a set of layers configured with a first set of quantization parameters.

5. The method of claim 4, wherein:
the second set of layers comprise a set of layers configured with a second set of quantization parameters, and
the second set of quantization parameters correspond to quantization over a smaller data type than the first set of quantization parameters.

6. The method of claim 3, wherein the first set of processing units comprises a neural processing unit (NPU), a digital signal processor (DSP), and a plurality of central processing unit (CPU) cores.

7. The method of claim 6, wherein the second set of processing units comprises the plurality of CPU cores and a plurality of graphics processing unit (GPU) processors.

8. The method of claim 1, wherein selecting the second processing unit is further based on a ranking of types of processing units for executing operations in the second portion of the machine learning model.

9. The method of claim 8, wherein the ranking of types of processing units is based on a size of data processed using the second portion of the machine learning model and a level of performance associated with each type of processing unit in the computing device.

10. The method of claim 1, wherein the one or more operating parameters comprise one or more of a distance between one or more processing units and the first processing unit, a temperature of the one or more processing units, or a current load on the one or more processing units.

11. The method of claim 10, wherein selecting the second processing unit comprises selecting a processing unit a farthest distance away from the first processing unit having a measured temperature below a threshold temperature.

12. The method of claim 10, wherein selecting the second processing unit comprises:
identifying a set of processing units having distances from the first processing unit exceeding a distance threshold and measured temperatures below a threshold temperature; and
selecting the second processing unit from the identified set of processing units.

13. The method of claim 12, wherein identifying the set of processing units further comprises identifying processing units having a current load less than a threshold load.

14. A processing system, comprising:
a memory comprising computer-executable instructions; and
one or more processors configured to execute the computer-executable instructions and cause the processing system to:
measure, during execution of operations in a first portion of a machine learning model on a first processing unit of a computing device, a temperature for each of a plurality of locations on the computing device;
determine that a temperature measured for the first processing unit exceeds a threshold temperature;
select, based on one or more operating parameters for the computing device, a second processing unit of the computing device to use in executing operations in a second portion of the machine learning model; and
schedule execution of operations in the second portion of the machine learning model on the second processing unit.

15. The processing system of claim 14, wherein the first portion of the machine learning model and the second portion of the machine learning model comprise layers of a neural network configured for execution on a same set of processing units.

16. The processing system of claim 14, wherein the first portion of the machine learning model is a member of a first set of layers configured for execution on a first set of processing units of the computing device and the second portion of the machine learning model is a member of a second set of layers configured for execution on a second set of processing units of the computing device.

17. The processing system of claim 16, wherein the first set of layers comprise a set of layers configured with a first set of quantization parameters.

18. The processing system of claim 17, wherein:
the second set of layers comprise a set of layers configured with a second set of quantization parameters, and
the second set of quantization parameters correspond to quantization over a smaller data type than the first set of quantization parameters.

19. The processing system of claim 16, wherein the first set of processing units comprises a neural processing unit (NPU), a digital signal processor (DSP), and a plurality of central processing unit (CPU) cores.

20. The processing system of claim 19, wherein the second set of processing units comprises the plurality of CPU cores and a plurality of graphics processing unit (GPU) processors.

21. The processing system of claim 14, wherein the processor is configured to select the second processing unit further based on a ranking of types of processing units for executing operations in the second portion of the machine learning model.

22. The processing system of claim 21, wherein the ranking of types of processing units is based on a size of data processed using the second portion of the machine learning model and a level of performance associated with each type of processing unit in the computing device.

23. The processing system of claim 14, wherein the one or more operating parameters comprise one or more of a distance between one or more processing units and the first processing unit, a temperature of the one or more processing units, or a current load on the one or more processing units.

24. The processing system of claim 23, wherein in order to select the second processing unit, the processor is configured to select a processing unit a farthest distance away from the first processing unit having a measured temperature below a threshold temperature.

25. The processing system of claim 23, wherein in order to select the second processing unit, the processor is configured to:
identify a set of processing units having distances from the first processing unit exceeding a distance threshold and measured temperatures below a threshold temperature; and
select the second processing unit from the identified set of processing units.

26. The processing system of claim 25, wherein in order to identify the set of processing units, the processing system is further configured to identify processing units having a current load less than a threshold load.

27. A processing system, comprising:
means for measuring, during execution of operations in a first portion of a machine learning model on a first processing unit of a computing device, a temperature for each of a plurality of locations on the computing device;
means for determining that a temperature measured for the first processing unit exceeds a threshold temperature;
means for selecting, based on one or more operating parameters for the computing device, a second processing unit of the computing device to use in executing operations in a second portion of the machine learning model; and
means for scheduling execution of operations in the second portion of the machine learning model on the second processing unit.

28. A non-transitory computer-readable medium comprising computer-executable instructions that, when executed by one or more processors of a processing system, cause the processing system to perform a method comprising:
during execution of operations in a first portion of a machine learning model on a first processing unit of a computing device, measuring a temperature for each of a plurality of locations on the computing device;
determining that a temperature measured for the first processing unit exceeds a threshold temperature;
selecting, based on one or more operating parameters for the computing device, a second processing unit of the computing device to use in executing operations in a second portion of the machine learning model; and
scheduling execution of operations in the second portion of the machine learning model on the second processing unit.
